(19) United States
(12) Patent Application Publication
(10) Pub. No.: US 2012/0271956 A1
(43) Pub. Date: Oct. 25, 2012

(54) TRANSMISSION APPARATUS, TRANSMISSION CONTROL METHOD, AND TRANSMISSION CONTROL PROGRAM

(75) Inventor: Kunitake Sugimoto, Kawasaki (JP)

(73) Assignee: FUJITSU LIMITED, Kawasaki-shi (JP)

(21) Appl. No.: 13/406,830

(22) Filed: Feb. 28, 2012

(30) Foreign Application Priority Data
Apr. 19, 2011 (JP) 2011-093115

(51) Int. Cl. G06F 15/16

(52) U.S. Cl. 709/227

(57) ABSTRACT

A transmission apparatus holds user information of an external device for a predetermined period of time and maintains a second protocol session between the own apparatus and another transmission apparatus for the predetermined period of time when a first protocol session between the external device and the own apparatus is disconnected. After the first protocol session is newly established, when a log-in is requested from an external device within the predetermined period of time, the transmission apparatus determines whether the user information of the external device that requested the log-in matches the user information it holds. When these pieces of user information match, the transmission apparatus connects the first protocol session newly established with the second protocol session maintained.

### CROSS-REFERENCE TO RELATED APPLICATION

This application is based upon and claims the benefit of priority of the prior Japanese Patent Application No. 2011-093115, filed on Apr. 19, 2011, the entire contents of which are incorporated herein by reference.

### FIELD

The embodiments discussed herein are directed to a transmission apparatus, a transmission control method, and a transmission control program.

### BACKGROUND

Conventionally, there are networks that maintain security with session management and that include a plurality of transmission apparatuses being accessed by an external device. As one situation, with one transmission apparatus as a relay point, an external device accesses other transmission apparatuses. At this time, session management is carried out by the transmission apparatus serving as the relay point because the session management is carried out under the same protocol.

FIG. 10 is a block diagram illustrating an example of a network including a plurality of transmission apparatuses. With reference to FIG. 10, a monitoring device is illustrated as an example of an external device, and a situation of the monitoring device monitoring a plurality of transmission apparatuses with one transmission apparatus serving as a relay point will be described. Furthermore, a protocol between the monitoring device and the transmission apparatus serving as the relay point and a protocol between the transmission apparatus serving as the relay point and the other transmission apparatuses differ from each other. As one situation, the protocol between the monitoring device and the transmission apparatus serving as the relay point is the transmission control protocol/Internet protocol (TCP/IP protocol). Meanwhile, the protocol between the transmission apparatus serving as the relay point and the other transmission apparatuses is the open system interconnection (OSI) protocol.

In the above-described configuration, the monitoring device logs in to these transmission apparatuses with the same user name and monitors the transmission apparatuses. The transmission apparatus serving as the relay point carries out session management for each of the different protocols and executes conversion of the protocols and such to realize the communication between the monitoring device and the other transmission apparatuses. When a TCP/IP protocol session between the monitoring device and the transmission apparatus serving as the relay point is disconnected, OSI protocol sessions between the transmission apparatus serving as the relay point and the other transmission apparatuses are also disconnected. In other words, with the disconnection of TCP/IP protocol session as a trigger, a log-in state between the monitoring device and each of the transmission apparatuses changes into a log-off state. Thereafter, when the TCP/IP protocol session is restored, the monitoring device resumes communication by logging in to each of the transmission apparatuses again. As for resuming the communication, there have been some technologies disclosed to re-establish a session without a need of user authentication and to resume communication by maintaining a session under the same protocol by a proxy. These related-art examples are described, for example, in Japanese Laid-open Patent Publication No. 2007-157148, Japanese National Publication of International Patent Application No. 2007-514337, Japanese National Publication of International Patent Application No. 2008-527800, and Japanese Laid-open Patent Publication No. 10-285174.

In the conventional art, however, when a protocol session disconnected is restored, it takes a lot of time until the transmission between apparatuses becomes possible. In the conventional art, when a protocol session between the apparatuses connected by different protocol sessions is disconnected on the apparatus of an access source side, the protocol sessions on the other side are also disconnected. Because of this, when a protocol session is re-established, the external device needs to execute log-in processes to each of the transmission apparatuses. When the number of transmission apparatuses is huge, it takes a commensurate time. Therefore, when it is used in an application for monitoring and such, for example, it is undesirable because the time in which the monitoring is not possible becomes long. As for a user, it takes a lot of trouble to carry out log-in operations to the apparatuses and, furthermore, it increases a possibility of inducing errors in operation or the like.

### SUMMARY

According to an aspect of an embodiment of the invention, a transmission apparatus includes a first communication interface that controls communication in a first protocol session between an external device and the transmission apparatus, a second communication interface that controls communication in a second protocol session between the transmission apparatus and another transmission apparatus that is connectable with the external device via the transmission apparatus, and a processor that connects the first protocol session via the first communication interface with the second protocol session via the second communication interface, wherein the processor holds first user information of the external device for a predetermined period of time and maintains the second protocol session for the predetermined period of time when the first protocol session is disconnected, determines, when a log-in to the transmission apparatus or the another transmission apparatus is requested from an external device after the first protocol session is newly established, whether the first user information matches second user information of the external device that requests the log-in, and connects the newly established first protocol session with the maintained second protocol session when the match is determined.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a block diagram illustrating an example of a hardware configuration of a transmission apparatus according to a first embodiment;

FIG. 2 is a conceptual block diagram for explaining about firmware;

FIG. 3 is a chart illustrating an example of information held by a user manager;

FIG. 4 is a chart illustrating an example of information held by an initiator;

FIG. 5 is a block diagram for explaining about transmission controls when a protocol session between a monitoring device and a transmission apparatus is disconnected;

FIG. 6 is a block diagram for explaining about transmission controls when a log-in to the own apparatus is requested from the monitoring device after the protocol session between the monitoring device and the transmission apparatus is restored;

FIG. 7 is a block diagram for explaining about transmission controls when log-ins to other apparatuses are requested from the monitoring device after the protocol session between the monitoring device and the transmission apparatus is restored;

FIG. 8 is a flowchart illustrating an example of a flow of a transmission control process according to the first embodiment;

FIG. 9 is a block diagram illustrating a computer that executes a transmission control program; and

FIG. 10 is a block diagram illustrating an example of a network including a plurality of transmission apparatuses.

### DESCRIPTION OF EMBODIMENTS

Preferred embodiments of the present invention will be explained with reference to accompanying drawings. However, the invention is not intended to be restricted by the following embodiments.

### [a] First Embodiment

### Hardware Configuration of Transmission Apparatus

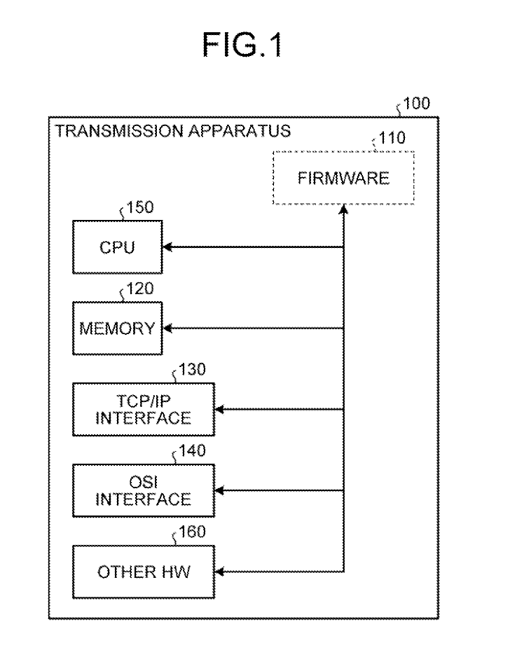

With reference to FIG. 1, a hardware configuration of a transmission apparatus according to a first embodiment will be described. FIG. 1 is a block diagram illustrating an example of a hardware configuration of the transmission apparatus according to the first embodiment.

For example, as illustrated in FIG. 1, a transmission apparatus 100 includes firmware 110, a memory 120, a TCP/IP interface 130, an OSI interface 140, a central processing unit (CPU) 150, and other hardware (HW) 160. The transmission apparatus 100 is further connected with an external device such as a monitoring device that monitors a plurality of transmission apparatuses, and with other transmission apparatuses different from the transmission apparatus 100.

The firmware 110, for example, controls respective hardware included in the transmission apparatus 100. The details of the firmware 110 will be described later. The memory 120, for example, stores therein data for various processes performed by the CPU 150, and results of the various processes performed by the CPU 150. The memory 120, for example, is a semiconductor memory device such as a random access memory (RAM), a read only memory (ROM), and a flash memory, or a storage device such as a hard disk drive and an optical disk drive.

The TCP/IP interface 130, for example, controls communication in TCP/IP protocol sessions between the transmission apparatus 100 and the monitoring device. The OSI interface 140, for example, controls communication in OSI protocol sessions between the transmission apparatus 100 and the other transmission apparatuses. The TCP/IP interface 130 and the OSI interface 140 are only needed to be an interface concerning a protocol different from each other, and are not limited as such. As for the protocols, for example, internetwork packet exchange/sequenced packet exchange (IPX/SPX) and NetBIOS extended user interface (NETBEUI) can be named. For example, AppleTalk (registered trademark), and B Plus can be further named as the protocols. The protocols between the transmission apparatus 100 and the monitoring device and between the transmission apparatus 100 and the other transmission apparatuses can be realized by any combination of the above-described different protocols. In the following, as one situation, the use of TCP/IP protocol sessions and OSI protocol sessions will be exemplified.

The CPU 150 controls the whole of the transmission apparatus 100 and, for example, uses the firmware 110 to connect TCP/IP protocol sessions via the TCP/IP interface 130 with OSI protocol sessions via the OSI interface 140. The CPU 150 further carries out session management for the respective different protocols and executes conversion of the protocols.

More specifically, when a TCP/IP protocol session is disconnected, the CPU 150 holds user information of the monitoring device for a predetermined period of time and maintains OSI protocol sessions for the predetermined period of time. After a TCP/IP protocol session is newly established, when a log-in to the transmission apparatus 100 or to the other transmission apparatuses is requested from a monitoring device, the CPU 150 determines whether the user information it holds matches the user information of the monitoring device that requested the log-in. When these pieces of user information match, the CPU 150 connects the TCP/IP protocol session newly established with the OSI protocol sessions maintained. The other HW 160, for example, is a group of hardware different from the hardware described above.

Firmware

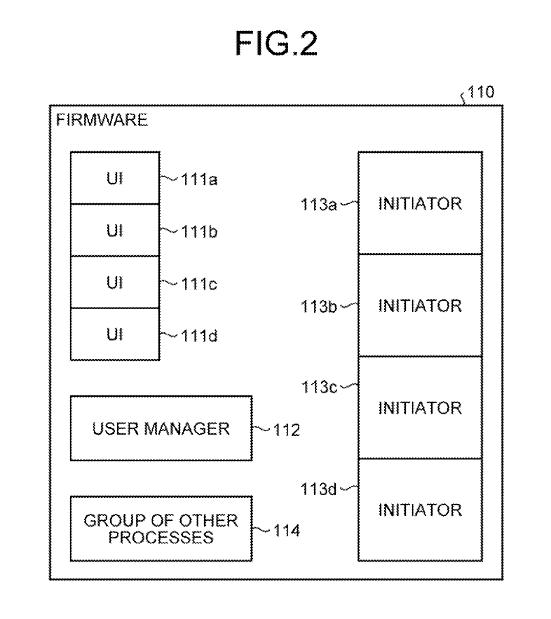

Next, with reference to FIG. 2, the firmware 110 will be explained. FIG. 2 is a conceptual block diagram for explaining about the firmware 110. For example, the firmware 110 includes user interfaces (UIs) 111a to 111d, a user manager 112, initiators 113a to 113d, and a group of other processes 114. While the numbers of processes of the UIs 111a to 111d and the initiators 113a to 113d are illustrated as four each in FIG. 2, they are not limited to this number.

The UIs 111a to 111d, for example, determine respective transmission apparatuses that are subjects of control by receiving control commands from a monitoring device. The transmission apparatus that is a subject of control here means, for example, a subject of monitoring by the monitoring device, more specifically, a transmission apparatus that is requested to log in by the monitoring device. The UIs 111a to 111d, for example, further make the user manager 112 hold the user information of the monitoring device requested to log in to the transmission apparatus 100. The UIs 111a to 111d, for example, select an unused initiator when a log-in request to other transmission apparatuses is received from the monitoring device.

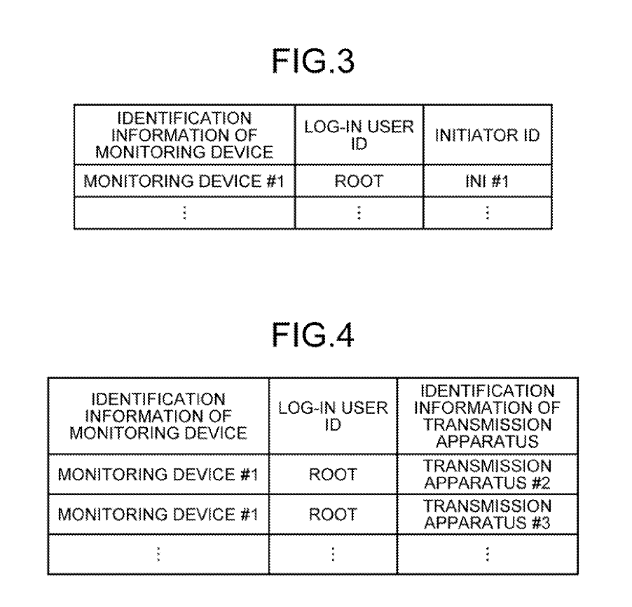

The user manager 112, for example, holds the user information of the monitoring device received from the UIs 111a to 111d. FIG. 3 is a chart illustrating an example of information held by the user manager 112. For example, as illustrated in FIG. 3, the user manager 112 holds identification information that identifies a monitoring device, a log-in user identifier (ID) indicative of identification information of a log-in user of the monitoring device, and an initiator ID indicative of identification information of a selected initiator being associated with one another. As an example, the user manager 112 holds the identification information of a monitoring device “MONITORING DEVICE #1”, a log-in user ID “ROOT”, and an initiator ID “INI #1” being associated with one another. The user manager 112 holds these pieces of information even after the disconnection of TCP/IP protocol session for a predetermined period of time, and deletes the information it holds when the predetermined period of time elapses.

The initiators 113a to 113d, for example, control respective connections with other transmission apparatuses that are subjects of monitoring by a monitoring device when selected by the UIs 111a to 111d. The initiators 113a to 113d, for example, maintain the respective connections with the other transmission apparatuses for the predetermined period of time when a TCP/IP protocol session is disconnected. The initiators 113a to 113d, for example, hold respective identification information that identifies other transmission apparatuses that are the subjects of monitoring by the monitoring device and user information of the monitoring device being associated with each other.

FIG. 4 is a chart illustrating an example of information held by the initiator 113a. For example, as illustrated in FIG. 4, the initiator 113a holds identification information that identifies a monitoring device, a log-in user ID indicative of identification information of a log-in user of the monitoring device, and identification information of other transmission apparatuses that are log-in request destinations being associated with one another. As an example, the initiator 113a holds the identification information of a monitoring device “MONITORING DEVICE #1”, a log-in user ID “ROOT”, and the identification information of a transmission apparatus “TRANSMISSION APPARATUS #2” being associated with one another. As another example, the initiator 113a holds the identification information of the monitoring device “MONITORING DEVICE #1”, the log-in user ID “ROOT”, and the identification information of a transmission apparatus “TRANSMISSION APPARATUS #3” being associated with one another.

More specifically, in the example illustrated in FIG. 4, it is indicated that the transmission apparatus 100 is logged in by the monitoring device with the identification information of “MONITORING DEVICE #1” using the log-in user ID of “ROOT”, and the monitoring device is logging in to the other transmission apparatuses with the identification information of “TRANSMISSION APPARATUS #2” and “TRANSMISSION APPARATUS #3”. The initiators 113a to 113d hold these pieces of information even after the disconnection of TCP/IP protocol session for a predetermined period of time and deletes the information they hold when the predetermined period of time elapses. The initiators 113a to 113d further disconnect the respective connections with the other transmission apparatuses maintained when the predetermined period of time elapses after the TCP/IP protocol session is disconnected. The group of other processes 114 is a group of processes that execute other controls for monitoring but different from the above-described processes.

Transmission Control

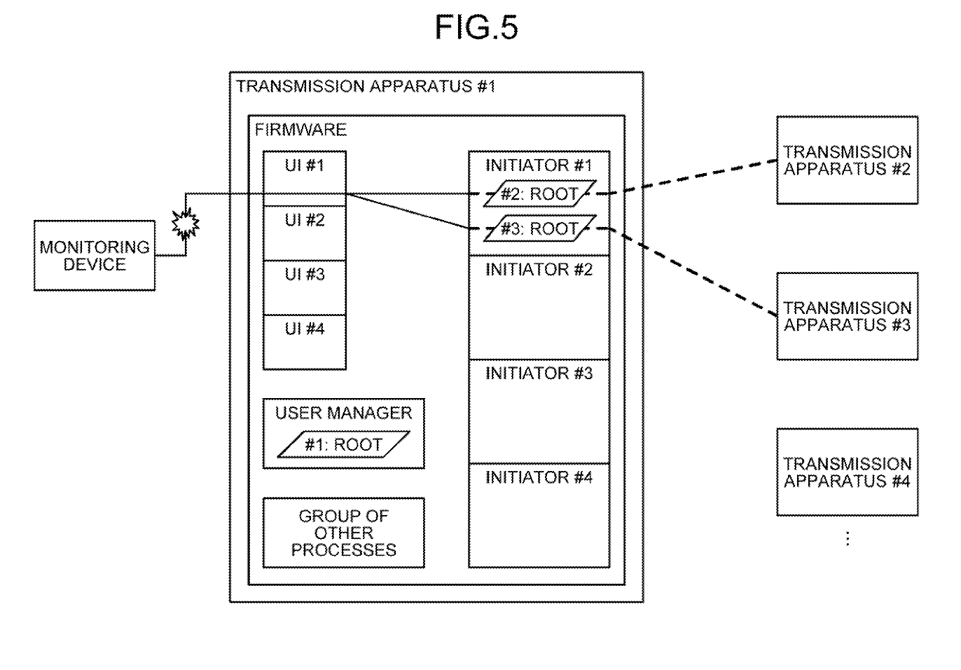

Next, with reference to FIGS. 5 to 7, transmission controls according to the first embodiment will be described. In FIGS. 5 to 7, a monitoring device that monitors a network including a transmission apparatus #1 to a transmission apparatus #4 logging in to any of the transmission apparatuses is exemplified. In FIGS. 5 to 7, exemplified is the monitoring device logging in to each of the transmission apparatuses with the transmission apparatus #1 serving as a relay point. In the following, it will be explained by illustrating the firmware of the transmission apparatus #1 for the sake of convenience of explanation.

When Session is Disconnected

FIG. 5 is a block diagram for explaining about transmission controls when a protocol session between a monitoring device and a transmission apparatus is disconnected. In the explanation with FIG. 5, it is assumed that the monitoring device is logging in to each of the transmission apparatuses of the transmission apparatus #1, the transmission apparatus #2, and the transmission apparatus #3 as the subjects of monitoring. More specifically, the monitoring device is logging in to the transmission apparatus #2 and the transmission apparatus #3 through a UI #1 and an initiator #1 of the transmission apparatus #1. Furthermore, the transmission apparatus #1 is holding the user information of the monitoring device by a user manager and holding the user information of the monitoring device and the identification information of the transmission apparatuses of connection destinations by the initiator #1.

In the above-described configuration, when a TCP/IP protocol session between the monitoring device and the transmission apparatus #1 is disconnected, the connection between the UI #1 and the initiator #1 is also disconnected. Accordingly, upon the disconnection of TCP/IP protocol session, the UI #1 makes the user manager hold the user information of the monitoring device logging in to the transmission apparatus #1 at that time for a predetermined period of time. For example, the user manager holds the identification information of the monitoring device “MONITORING DEVICE #1”, the log-in user ID “ROOT”, and the initiator ID “INI #1” being associated with one another for the predetermined period of time. However, the user manager does not hold the user information of the monitoring device when the transmission apparatus #1 that is the own apparatus is not a subject of monitoring.

Furthermore, upon the disconnection of TCP/IP protocol session, the initiator #1 holds the user information of the monitoring device logging in to the transmission apparatus #2 and the transmission apparatus #3 at that time and the identification information of the transmission apparatus #2 and the transmission apparatus #3 of connection destinations for the predetermined period of time. For example, the initiator #1 holds the identification information of the monitoring device “MONITORING DEVICE #1”, the log-in user ID “ROOT”, and the identification information of the transmission apparatus of connection destination “TRANSMISSION APPARATUS #2” being associated with one another for the predetermined period of time. The initiator #1, for example, further holds the identification information of the monitoring device “MONITORING DEVICE #1”, the log-in user ID “ROOT”, and the identification information of the transmission apparatus of connection destination “TRANSMISSION APPARATUS #3” being associated with one another for the predetermined period of time.

Upon the disconnection of TCP/IP protocol session, the initiator #1 further maintains OSI protocol sessions between the transmission apparatus #1 and the transmission apparatus #2 and between the transmission apparatus #1 and the transmission apparatus #3 for the predetermined period of time. In FIG. 5, dashed lines indicate the OSI protocol sessions between the transmission apparatus #1 and the transmission apparatus #2 and between the transmission apparatus #1 and the transmission apparatus #3 being maintained after the TCP/IP protocol session is disconnected. More specifically, even when the TCP/IP protocol session is disconnected, the transmission apparatus #1 maintains the OSI protocol sessions with the other transmission apparatuses to maintain log-in states for the transmission apparatus #2 and the transmission apparatus #3 by the monitoring device. In other words, when the TCP/IP protocol session is disconnected, the monitoring device is in log-off states for these transmission apparatuses while these transmission apparatuses with their OSI protocol sessions being maintained are in states of being logged in by the monitoring device.

Logging-in to Own Apparatus

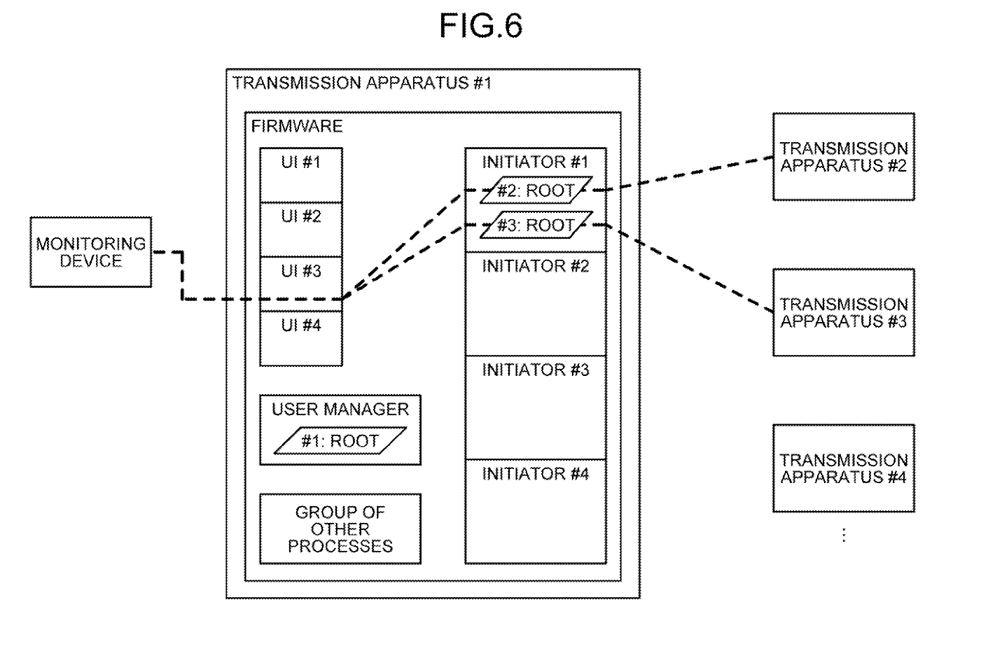

FIG. 6 is a block diagram for explaining about transmission controls when a log-in to the own apparatus is requested from a monitoring device after a protocol session between the monitoring device and the transmission apparatus is restored. In the explanation with FIG. 6, exemplified is a situation in which a TCP/IP protocol session is restored from the disconnection of TCP/IP protocol session explained with reference to FIG. 5. More specifically, after the TCP/IP protocol session is disconnected, the user manager of the transmission apparatus #1 is holding the identification information of the monitoring device “MONITORING DEVICE #1”, the log-in user ID “ROOT”, and the initiator ID “INI #1” being associated with one another for the predetermined period of time.

In the above-described configuration, when a log-in to the transmission apparatus #1 is requested from the monitoring device after the TCP/IP protocol session is restored within the predetermined period of time, the transmission apparatus #1 connects the TCP/IP protocol session with the OSI protocol sessions. For example, when a log-in request is received from the monitoring device within the predetermined period of time, the UI #3 determines whether the user information held by the user manager matches the user information of the monitoring device that requested the log-in. When the identification information of the monitoring device that requested the log-in is “MONITORING DEVICE #1” and the log-in user ID is “ROOT”, the UI #3 determines that the both user information match and then selects the initiator #1 with the initiator ID of “INI #1”. While it is exemplified that the UI #3 receives a log-in request from a monitoring device here, the transmission apparatus that received the log-in request from the monitoring device merely uses an unused UI and it is not restricted to use the UI #3.

The initiator #1 selected by the UI #3 is in a state of maintaining the OSI protocol sessions between the transmission apparatus #1 and the transmission apparatus #2 and between the transmission apparatus #1 and the transmission apparatus #3 for the predetermined period of time. This allows the monitoring device, after the log-in request to the transmission apparatus #1, to instantly change into a state of logging in also to the transmission apparatus #2 and the transmission apparatus #3. In FIG. 6, dashed lines indicate a state of the monitoring device logging in to the transmission apparatus #1, the transmission apparatus #2, and the transmission apparatus #3 after the TCP/IP protocol session is restored.

Meanwhile, when the user information held by the user manager is determined not to match the user information of a monitoring device that requested the log-in, the UI #3 executes a normal log-in process as explained in the assumption with reference to FIG. 5. In a normal log-in process, when it is within the predetermined period of time, the initiator #1 that is maintaining the OSI protocol sessions with the transmission apparatus #2 and the transmission apparatus #3 is never used. At that time, when it is within the predetermined period of time after the TCP/IP protocol session is disconnected, the information held by the user manager is not deleted either.

Log-in to Another Apparatus

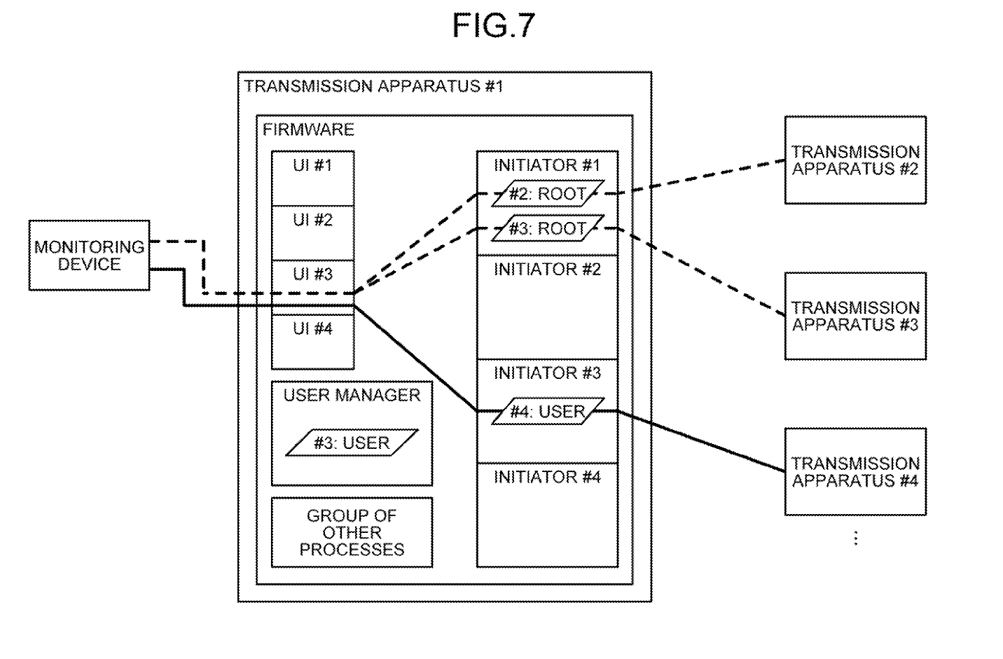

FIG. 7 is a block diagram for explaining about transmission controls when a log-in to other transmission apparatuses is requested from the monitoring device after a protocol session between the monitoring device and the transmission apparatus is restored. In the explanation with FIG. 7, exemplified is a situation in which the monitoring device is logging in to the transmission apparatus #2 and the transmission apparatus #3 in the explanation with FIG. 5 except for the transmission apparatus #1. In addition to that, in the explanation with FIG. 7, exemplified is a situation in which a TCP/IP protocol session is restored from the disconnection of TCP/IP protocol session. More specifically, after the TCP/IP protocol session is disconnected, the initiator #1 is holding the identification information of the monitoring device “MONITORING DEVICE #1”, the log-in user ID “ROOT”, and the identification information of the transmission apparatus #2 “TRANSMISSION APPARATUS #2” that is the connection destination being associated with one another for the predetermined period of time. Similarly, the initiator #1 is holding the identification information of the monitoring device “MONITORING DEVICE #1”, the log-in user ID “ROOT”, and the identification information of the transmission apparatus #3 “TRANSMISSION APPARATUS #3” that is the connection destination being associated with one another for the predetermined period of time after the disconnection of TCP/IP protocol session.

In the above-described configuration, after the TCP/IP protocol session is restored, when a log-in to the transmission apparatus #2 or to the transmission apparatus #3 is requested from the monitoring device within the predetermined period of time, the transmission apparatus #1 connects the TCP/IP protocol session with the OSI protocol sessions. For example, when a log-in request to the other transmission apparatuses is received from the monitoring device within the predetermined period of time, the UI #3 determines whether the user information held by the respective initiators match the user information of the monitoring device that requested the log-in. When the identification information of the monitoring device that requested the log-in is “MONITORING DEVICE #1” and the log-in user ID is “ROOT”, the UI #3 determines that the user information held by the initiator #1 matches and then selects the initiator #1. At the time, the UI #3 may determine whether the identification information of the other transmission apparatuses that are the connection destinations contained in the log-in request received from the monitoring device match the identification information of the other transmission apparatuses that are the connection destinations held by the respective initiators. While it is exemplified that the UI #3 receives a log-in request from a monitoring device here, the transmission apparatus that received the log-in request from the monitoring device merely uses an unused UI, and it is not restricted to use the UI #3.

The initiator #1 selected by the UI #3 is in a state of maintaining the OSI protocol sessions between the transmission apparatus #1 and the transmission apparatus #2 and between the transmission apparatus #1 and the transmission apparatus #3 for the predetermined period of time. This allows the monitoring device, after the log-in requests to the transmission apparatus #2 and the transmission apparatus #3, to instantly change into a state of logging in to those transmission apparatuses. In FIG. 7, dashed lines indicate a state of the monitoring device logging in to the transmission apparatus #2 and the transmission apparatus #3 after the TCP/IP protocol session is restored.

Meanwhile, when the identification information of a monitoring device that requested the log-in is “MONITORING DEVICE #1” and a log-in user ID is “USER”, the UI #3 determines that they do not match the user information held by the respective initiators and then selects the initiator #3. The initiator selected here is an initiator that is not maintaining OSI protocol sessions with other transmission apparatuses. The initiator #3 establishes an OSI protocol session with the transmission apparatus #4, and then holds the identification information of the monitoring device that requested the log-in “MONITORING DEVICE #1”, the log-in ID “USER”, and the identification information of the transmission apparatus #4 “TRANSMISSION APPARATUS #4” that is the connection destination being associated with one another. When the transmission apparatus #1 is also a subject of log-in at the time of logging in to the transmission apparatus #4, the UI #3 makes the user manager hold the identification information of the monitoring device “MONITORING DEVICE #1”, the log-in user ID “USER”, and the initiator ID “INI #3” being associated with one another. In FIG. 7, solid lines indicate a state of the monitoring device logging in to the transmission apparatus #4 after the TCP/IP protocol session is restored. At that time, the information held by the initiator #1 is not deleted either when it is within the predetermined period of time after the TCP/IP protocol session is disconnected. In FIG. 7, while both the dashed lines and the solid lines indicating the states of logging in to the other transmission apparatuses are illustrated to go through the UI #3 for the sake of convenience of explanation, a single UI is never used doubly in reality.

Transmission Control Process Flow According to First Embodiment

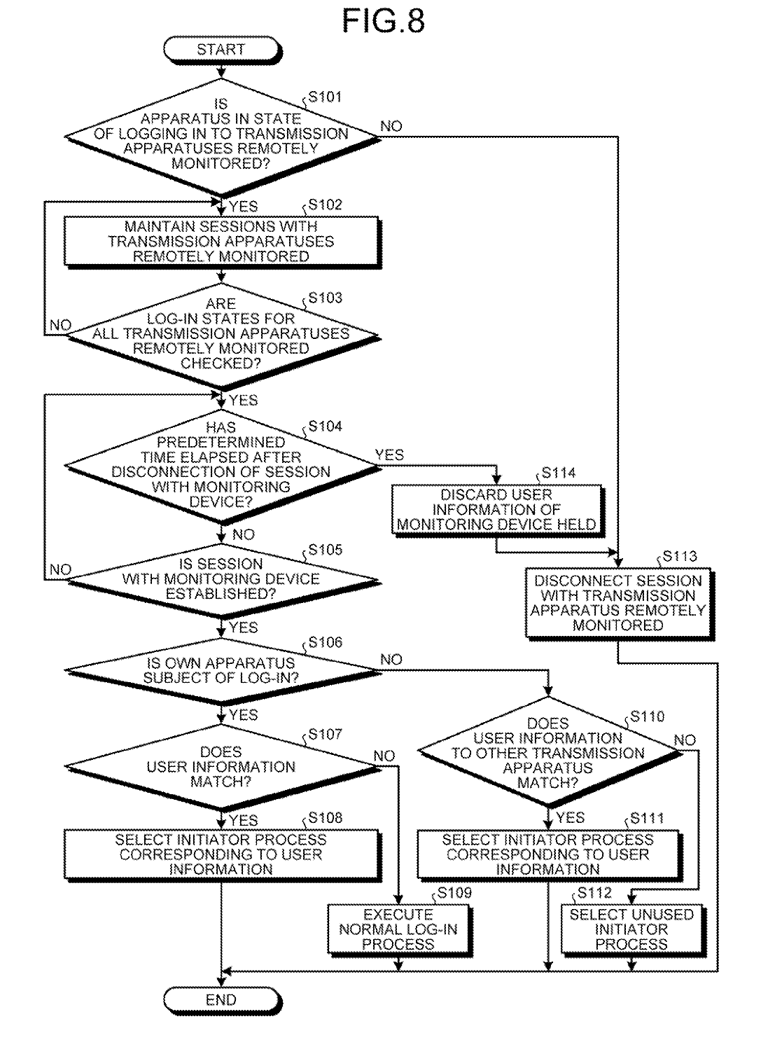

Next, with reference to FIG. 8, a transmission control process according to the first embodiment will be explained. FIG. 8 is a flowchart illustrating an example of a flow of the transmission control process according to the first embodiment. In the following, explained will be a transmission control process when a TCP/IP protocol session between a monitoring device and the transmission apparatus 100 is disconnected.

For example, as illustrated in FIG. 8, when the transmission apparatus 100 is in a state of logging in to other transmission apparatuses that are remotely monitored (Yes at S101), the transmission apparatus 100 maintains OSI protocol sessions with the other transmission apparatuses being remotely monitored (S102). The transmission apparatus 100 then determines whether log-in states maintained for all of the other transmission apparatuses being remotely monitored are checked and, when there is any unchecked apparatus (No at S103), the transmission apparatus 100 executes the process at 5102.

When all of the log-in states are checked (Yes at S103), the transmission apparatus 100 determines whether a predetermined period of time has elapsed from the disconnection of TCP/IP protocol session with the monitoring device (S104). At that time, when the predetermined period of time has not elapsed (No at S104), the transmission apparatus 100 determines whether a TCP/IP protocol session is established with a monitoring device (S105). When a TCP/IP protocol session is not established (No at S105), the transmission apparatus 100 then executes the process at 5104.

When a TCP/IP protocol session is established (Yes at S105), the transmission apparatus 100 determines whether the own apparatus is included in the subjects of log-in by the monitoring device (S106). At that time, when the own apparatus is included in the subjects of log-in (Yes at S106), the transmission apparatus 100 determines whether the user information of the monitoring device matches the user information it holds (S107).

When these pieces of user information match (Yes at S107), the transmission apparatus 100 selects an initiator process corresponding to the user information it holds (S108). The initiator process selected is maintaining the OSI protocol sessions with the other transmission apparatuses. Accordingly, the transmission apparatus 100 connects the TCP/IP protocol session established with the OSI protocol sessions maintained to make the monitoring by the monitoring device instantly change into a log-in state. Meanwhile, when these pieces of user information do not match (No at S107), the transmission apparatus 100 executes a normal log-in process (S109).

When the own apparatus is not included in the subjects of log-in (No at S106), the transmission apparatus 100 determines whether the user information of the monitoring device matches the user information it holds corresponding to the log-ins to the other transmission apparatuses (S110). When these pieces of user information match (Yes at 5110), the transmission apparatus 100 then selects an initiator process that is holding the matched user information (S111). The selected initiator process is maintaining the OSI protocol sessions with the other transmission apparatuses. Accordingly, the transmission apparatus 100 connects the TCP/IP protocol session established with the OSI protocol sessions maintained to make the monitoring by the monitoring device instantly change into a log-in state. Meanwhile, when these pieces of user information do not match (No at S110), the transmission apparatus 100 selects an unused initiator process (S112).

When the transmission apparatus 100 is not in a state of logging in to the other transmission apparatuses being remotely monitored (No at S101), the transmission apparatus 100 disconnects the OSI protocol sessions (S113). In other words, the monitoring by the monitoring device is turned into a log-off state. Furthermore, when the predetermined period of time has elapsed (Yes at S104), the transmission apparatus 100 discards the user information of the monitoring device held (S114). The discarded information at that time corresponds to the information indicated in FIGS. 3 and 4. Thereafter, the transmission apparatus 100 disconnects the OSI protocol sessions (S113). In this case, the monitoring by the monitoring device is also turned into a log-off state.

### Effects of First Embodiment

As described in the foregoing, when a protocol session with an external device such as a monitoring device is disconnected, the transmission apparatus 100 maintains protocol sessions with other transmission apparatuses for a predetermined period of time and holds the user information of the external device for the predetermined period of time. When a log-in is requested from an external device after a protocol session with the external device is restored, the transmission apparatus 100 then determines whether the user information of the external device that requested the log-in matches the user information it holds. When these pieces of user information match, the transmission apparatus 100 then connects the protocol session with the external device restored with the protocol sessions with the other transmission apparatuses maintained. As a result of the foregoing, the transmission apparatus 100 can reduce the time it takes until the transmission between apparatuses becomes possible, as compared with conventional art in which a log-in process is carried out to each of the transmission apparatuses. Furthermore, the transmission apparatus 100 makes a plurality of transmission apparatuses be monitored by making only a single transmission apparatus carry out a log-in process by the monitoring device, whereby the time in which the monitoring is not possible can be cut down. Moreover, the transmission apparatus 100 can reduce the burden of the user and operational errors caused by the user, as compared with conventional art in which a log-in process is carried out to each of the transmission apparatuses.

### [b] Second Embodiment

While the embodiment of the transmission apparatus 100 disclosed in the present application is described above, the invention may be implemented in various different embodiments other than the above-described embodiment. Accordingly, different embodiments in (1) determination of user information, (2) configuration, and (3) program will be explained.

(1) Determination of User Information

In determining user information, it is explained that whether the respective identification information that identify monitoring devices and the log-in user IDs match is determined in the above-described embodiment. However, it may be configured to determine whether at least the respective log-in user IDs match. Furthermore, while it is explained that, at the time a monitoring device logs in to the own apparatus, the connection with the maintained protocol sessions is made when these pieces of user information match, it may be configured to further determine whether these pieces of identification information of the other transmission apparatuses that are the connection destinations match. Moreover, while it is explained that, at the time a monitoring device logs in to other transmission apparatuses, whether these pieces of user information and the identification information of the other transmission apparatuses that are the connection destinations match is determined, it may be configured to only determine whether the respective log-in user IDs match.

When executing the connection with the maintained protocol sessions as the respective log-in user IDs match, the connection may be determined by a degree of coincidence of the identification information of the other transmission apparatuses that are the connection destinations with the identification information of the other transmission apparatuses to which the monitoring device is requesting to log in. For example, the transmission apparatus 100 may execute the connection only when all of the identification information match, or may execute the connection by the number of matches or a ratio of matches when a part of the identification information matches. More specifically, when a part of the identification information matches, log-in processes are executed for the other transmission apparatuses to which a log-in is needed and log-off processes are executed for the other transmission apparatuses to which a log-in is not needed.

(2) Configuration

The processing procedures, control procedures, specific names, and information including various types of data, parameters, and the like (for example, information stored by the user manager 112 and by the initiators) illustrated in the above documents and in the drawings can be optionally changed, except when specified otherwise. Furthermore, the information stored by the user manager 112 and the initiators only needs to be stored in any memory, and it is not limited to be stored in the user manager 112 and in the initiators.

The constituent elements such as the transmission apparatus 100 illustrated are functionally conceptual and are not necessarily configured physically as illustrated in the drawings. In other words, the specific embodiments of distribution or integration of these devices are not restricted to those illustrated, and the whole or a part thereof can be configured by being functionally or physically distributed or integrated in any unit according to various types of loads and usage. For example, the TCP/IP interface 130 or the OSI interface 140 may be a combination of different protocols, and may further have a plurality of interfaces corresponding to a plurality of protocols. Furthermore, the CPU 150 may be realized by a plurality of CPUs.

(3) Program

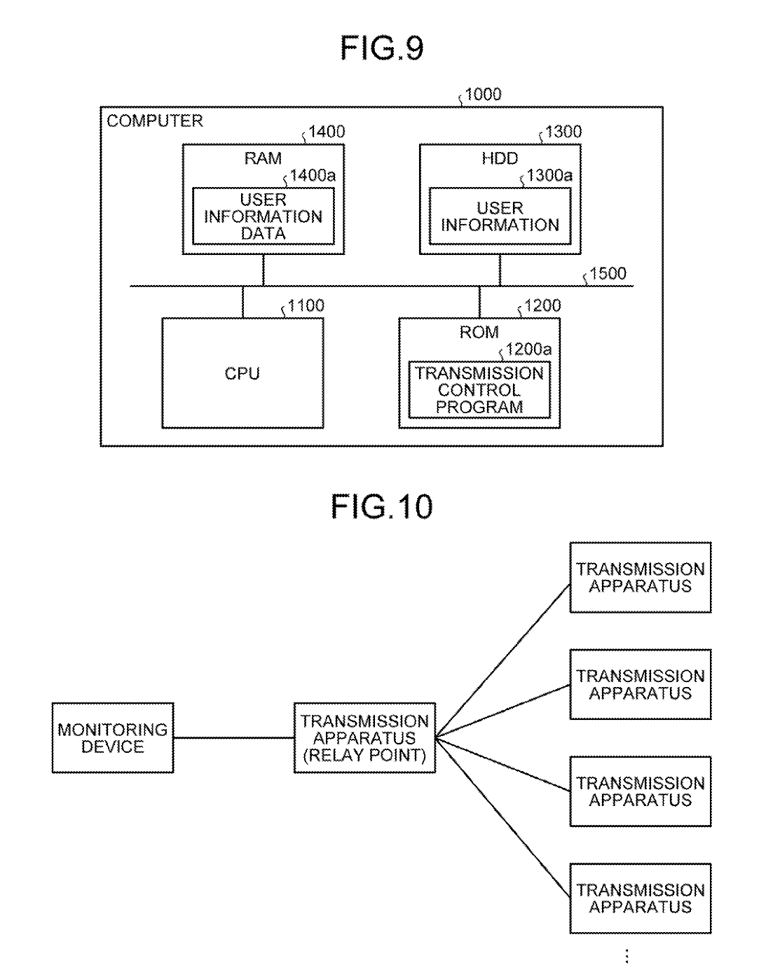

The various processes of the transmission apparatus explained in the above-described embodiment can be realized by executing a program prepared in advance by a computer system such as a personal computer and a workstation. Accordingly, with reference to FIG. 9, an example of a computer that executes a transmission control program having the same function as the transmission apparatus described in the embodiment above will be explained hereinafter. FIG. 9 is a block diagram illustrating a computer that executes the transmission control program.

As illustrated in FIG. 9, a computer 1000 includes a central processing unit (CPU) 1100, a read only memory (ROM) 1200, a hard disk drive (HDD) 1300, and a random access memory (RAM) 1400. These modules are connected with one another via a bus 1500.

In the ROM 1200, the transmission control program that exercises the same function as the CPU 150 illustrated in the first embodiment above is stored beforehand. More specifically, as illustrated in FIG. 9, the ROM 1200 stores therein a transmission control program 1200a. The transmission control program 1200a may be divided appropriately. The CPU 1100 then reads out the transmission control program 1200a from the ROM 1200 to execute the program. The HDD 1300 is provided with user information 1300a. The user information 1300a corresponds to the information held by the user manager illustrated in FIG. 3 or the information held by the initiator illustrated in FIG. 4.

The CPU 1100 then reads out the user information 1300a and stores the user information in the RAM 1400. The CPU 1100 further executes the transmission control program using user information data 1400a stored in the RAM 1400. As for the data stored in the RAM 1400, all of the data may not necessarily be stored in the RAM 1400 at all times, and only the data for a process needs to be stored. The transmission control program may not necessarily be stored in the ROM 1200 from the beginning.

For example, the program is stored in a portable physical medium such as a flexible disk (FD), a CD-ROM, a DVD disc, an optical disk, and an IC card that is inserted in the computer 1000. The computer 1000 may then be configured to read out the program from the foregoing to execute the program. Furthermore, the program is stored in another computer (or a server) and connected to the computer 1000 via a public line, the Internet, a LAN, a WAN or the like. The computer 1000 may be configured to read out the program from the foregoing to execute the program.

One aspect of a transmission apparatus, a transmission control method, and a transmission control program disclosed in the present application has an effect of reducing the time it takes until the transmission between apparatuses becomes possible.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission apparatus comprising:
a first communication interface that controls communication in a first protocol session between an external device and the transmission apparatus;
a second communication interface that controls communication in a second protocol session between the transmission apparatus and another transmission apparatus that is connectable with the external device via the transmission apparatus; and
a processor that connects the first protocol session via the first communication interface with the second protocol session via the second communication interface, wherein
the processor
holds first user information of the external device for a predetermined period of time and maintains the second protocol session for the predetermined period of time when the first protocol session is disconnected;
determines, when a log-in to the transmission apparatus or the another transmission apparatus is requested from an external device after the first protocol session is newly established, whether the first user information matches second user information of the external device that requests the log-in; and
connects the newly established first protocol session with the maintained second protocol session when the match is determined.

2. A transmission control method comprising:
holding first user information of an external device for a predetermined period of time and maintaining a second protocol session between a transmission apparatus and another transmission apparatus that is connectable with the external device via the transmission apparatus for the predetermined period of time when a first protocol session between the external device and the transmission apparatus is disconnected;
determining, when a log-in to the transmission apparatus or the another transmission apparatus is requested from an external device after the first protocol session is newly established, whether the first user information matches second user information of the external device that requests the log-in; and
connecting the newly established first protocol session with the maintained second protocol session when the match is determined.

3. A non-transitory computer-readable medium storing program causing a computer to execute a procedure, the procedure comprising:
holding first user information of an external device for a predetermined period of time and maintaining a second protocol session between a transmission apparatus and another transmission apparatus that is connectable with the external device via the transmission apparatus for the predetermined period of time when a first protocol session between the external device and the transmission apparatus is disconnected;
determining, when a log-in to the transmission apparatus or the another transmission apparatus is requested from an external device after the first protocol session is newly established, whether the first user information matches second user information of the external device that requests the log-in; and
connecting the newly established first protocol session with the maintained second protocol session when the match is determined.

4. The non-transitory computer-readable medium according to claim 3, wherein
the maintaining includes holding the first user information and identification information of the another transmission apparatus for the predetermined period of time when the first protocol session is disconnected while the external device is logging in to the another transmission apparatus, and
the determining includes determining, when the log-in to the another transmission apparatus is requested from the external device, whether the first user information and the identification information match the second user information of the external device that requested the log-in and identification information of a transmission apparatus of a log-in destination requested, respectively.

5. The non-transitory computer-readable medium according to claim 3, wherein
the maintaining includes a first process that maintains the second protocol session for the predetermined period of time,
the determining includes a second process that determines whether the first user information matches the second user information of the external device that requests the log-in, and
the second process connects the newly established first protocol session with the maintained second protocol session when the match is determined.
